(19) United States
(12) Patent Application Publication
(10) Pub. No.: US 2014/0040311 A1
(43) Pub. Date: Feb. 6, 2014

(54) METHOD FOR QUERYING A RESOURCE METADATA AND/OR RELATED INFORMATION

(71) Applicants: Diego Gonzalez Martinez, Madrid (ES); Pedro Diez Garcia, Madrid (ES)

(72) Inventors: Diego Gonzalez Martinez, Madrid (ES); Pedro Diez Garcia, Madrid (ES)

(21) Appl. No.: 14/002,611

(22) PCT Filed: Aug. 12, 2011
(86) PCT No.: PCT/EP11/04056

§ 371 Date: Oct. 18, 2013

Related U.S. Application Data
(60) Provisional application No. 61/448,875, filed on Mar. 3, 2011.

(51) Int. Cl. G06F 17/30

(52) U.S. Cl. CPC G06F 17/30424
USPC 707/770

(57) ABSTRACT

The method comprises said resource being an item used within system databases to group or nest related information stored in said system databases. Said query comprises discovering said resource and obtaining at least part of said related information wherein said discovering comprises checking the existence of said resource.

The method further comprises performing said query under at least a specific criterion or a set of conditions.

### FIELD OF THE ART

The present invention generally relates to a method for querying a resource, said resource being an item used within system databases to group or nest related information stored in said system databases and said query comprising discovering said resource and obtaining at least part of said related information, said discovering comprising checking the existence of said resource, and more particularly to a method which comprises performing said query under at least a specific criterion or a set of conditions.

### PRIOR STATE OF THE ART

Nowadays, immersed in the “Society of Information” era, informatics systems and infrastructures hold and store a huge amount of information, frequently categorized and/or hierarchical in order to get a better comprehension or handling of them. Moreover, this information may be distributed along several machines which may constitute a challenge when some valuable information is desired to be extracted.

In addition, it is a non-reversible process the migration from the stand-alone applications (proprietary, rigid to fulfil with a specific need within an enterprise) to the open-garden scope of internet applications, easier to understand and with a fast time-to-market features.

However, despite the existence and combination of the aforementioned factors (i.e. the increase of stored information and its access by a restricted stand-alone solution or an opened internet-based one), one key issue still remains valid: how to obtain and therefore exploit such information for several and different purposes in a flexible way.

The issue of obtaining suitable information from a back-end system is not new, and several existing technologies try to address this need:
Z39.50 [1] is a client-server protocol for searching and retrieving information from remote computer databases. It is covered by ANSI/NISO standard Z39.50, and ISO standard 23950. Its main scope is library and archive environments.

Its syntax, abstracted from the underlying database structure, allows formulating queries without having to know anything about the target database. As a drawback, this situation can lead to undesired behavior (i.e. non desired/expected responses).

However, it is a pre-Web technology, so some efforts are being made in order to spread its scope to internet technologies. It is worth noting the twin protocols SRU/SRW (Search-Retrieve via URL/Search-Retrieve Web service).
SRU/SRW. These protocols aim at enabling search queries in a web-based environment, by using HTTP queries and attempting to preserve the benefits of the Z39.50 query syntax.

Search/Retrieve via URL (SRU) is a standard search protocol for Internet search queries, REST-based and enables queries to be expressed in URL query strings [2]. Search/Retrieve Web service (SRW) is a web service for search and retrieval, providing a SOAP interface to query, which augments the URL interface provided by its companion protocol [3]. In both cases, queries are expressed using the Contextual Query Language (CQL) [4]. Both expect search results to be returned as XML.
eXtensible Resource Identifier (XRI) [5] provides a uniform syntax for abstract structured identifiers. XRIs may be used across a wide variety of communities and applications (as Web addresses, database keys, filenames, object IDs, XML IDs, tags, etc.), no single resolution mechanism may prove appropriate for all XRIs. In simple words, it defines a “terminology” to identify resources. Based on it, an XRI resolution protocol (i.e. procedure) may be applied, in order to identify the target resource whose details are required to be obtained.

Typically and in the interest of promoting interoperability, for both resolving an XRI and providing the details of a target resource a common XML format for discovery of metadata is used. This common format is named XRDS (eXtensible Resource Descriptor Sequence), which enables in a flexible and extensible way handling such metadata. A XRDS “document” comprises one or more XRD (Extensible Resource Descriptor) elements, which can easily be extended to publish any form of metadata about the resources they describe. Over such way of conveyance the information HTTP(s) queries are usually used to trigger the queries.

These existing solutions present some problems listed below:
Unsuitability for Internet deployments, as in the case of Z39.50.
Complexity, in terms of a specific parameterization, to group and show information.
Specific processing to be implemented in client and server sides for the solution to work.
Existing solutions don't provide criteria-based discovery, i.e.: do not provide means to discover resource availability under certain pre-conditions or factors.

### DESCRIPTION OF THE INVENTION

It is necessary to offer an alternative to the state of the art which covers the gaps found therein, particularly related to the lack of proposals which really enables a simple, flexible and extensible procedure to discover the availability of a resource and to obtain the information related to said resource.

To that end, the present invention provides a method for querying a resource metada and/or related information, said resource being an item used within system databases to group or nest related information stored in said system databases and said query comprising discovering said resource and obtaining at least part of said related information, said discovering comprising checking the existence of said resource.

On contrary to the known proposals, in the method of the invention, in a characteristic manner it further comprises performing said query under at least a specific criterion or set of conditions in a re-usable strategic to be implemented by different internet technologies.

Other embodiments of the method of the first aspect of the invention are described according to appended claims 2 to 15, and in a subsequent section related to the detailed description of several embodiments.

### BRIEF DESCRIPTION OF THE DRAWINGS

The previous and other advantages and features will be more fully understood from the following detailed description of embodiments, with reference to the attached drawing, which must be considered in an illustrative and non-limiting manner, in which:

FIG. 1 shows the interaction between entities to check the existence of a specific resource and to obtain the available resource and its related information, according to an embodiment of the present invention.

FIG. 2 shows the concrete instructions between entities to check the existence of a specific resource, according to an embodiment of the present invention.

FIG. 3 shows the concrete instructions between entities in order to get a specific resource and its related information, according to an embodiment of the present invention.

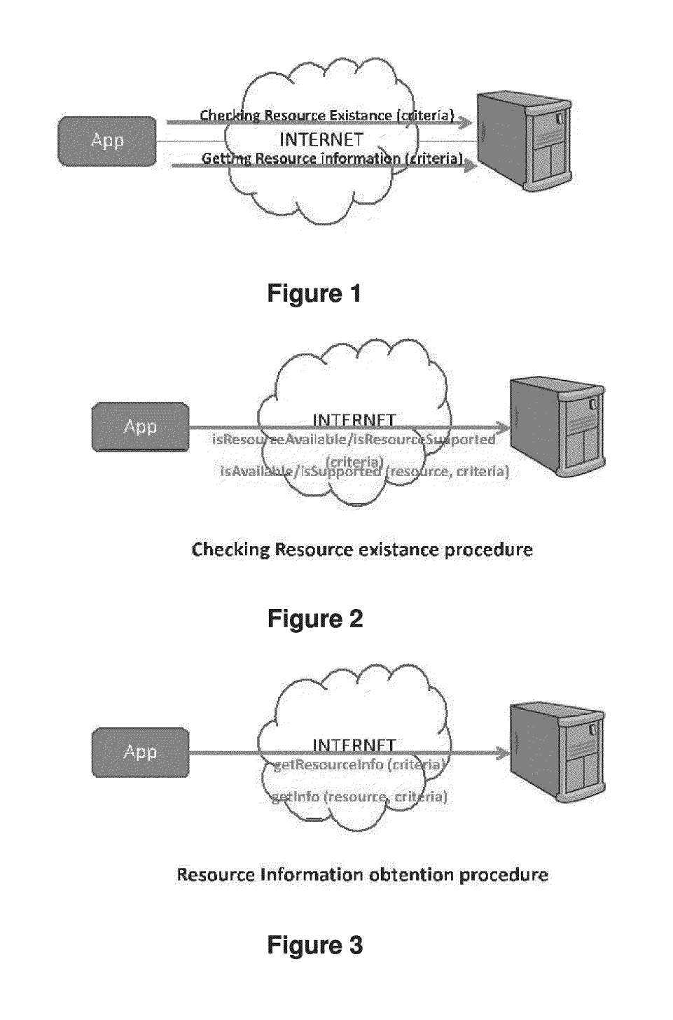

### DETAILED DESCRIPTION OF SEVERAL EMBODIMENTS

The underlying idea of the procedure is the ‘resource’ concept. A ‘resource’ may be interpreted as any item used within system databases to group/nest its stored information. The present invention applies REST concepts into a discovery mechanism, enabling a way for auto discovering which resources are available for a certain user, country, etc. (from a high level point of view under any specific or set of conditions) and giving the needed information for accessing the resource.

Based on it, two main procedures are defined:
Checking the existence of an specific resource
Obtaining an available resource/s and its related information

The step further with this solution is that several criteria can be added to aforementioned procedures to limit the scope of the searching. Thus, this procedure is not a mere resource discovery process but a resource availability query, where the Application (resource Consumer) can check the resource availability and the relevant metadata under certain criteria, such as ‘resource available for a certain user’, ‘resource available for user of certain company’, ‘resource available in current location of user’, etc.

This procedure may be implemented in any kind of external entity (i.e. Application): stand-alone applications, mobile applications or desktop applications.

The ‘discovery resource’ approach is sustained in two basic concepts:
‘Resource’: Identifies any potential ‘key’ item/entity used in a system database to group/nest information.
‘Criteria’: Establishes any filter or set of filters to limit/refine the scope of desired information about a resource to be obtained/shown or the conditions under them the query is attempted.

The novelty of the invention does not reside in a method to discover items (based on resource concept) and report information about them, issue that is covered by other solutions as well, but in making it ‘criteria-based’, allowing for its ‘discovery’ under certain conditions.

Furthermore, in the information obtained about resources valuable information may be returned. More specific information is detailed below.

Based on it, two main procedures can be defined:

1. First one is checking about availability of a specific resource. Different paradigms, as shown in FIG. 2, can be followed to implement the procedure, as per below mentioned:

a) Providing semantic about resource in the query itself (e.g. is ‘Resource’Available/is‘Resource’Supported are examples for primitive names replacing ‘Resource’ for the name of the resource). Furthermore, the procedure may be provided with some added flexibility to query ‘resource availability’ under some criteria/conditions (e.g. is‘Resource’Available/is‘Resource’Supported(criteria [ ]))

b) Identifying the resource explicitly in the query (e.g. isAvailable/isSupported (resource, criteria [ ]). In the same fashion as before, criteria may be used to establish some query conditions.

Regardless the paradigm to be followed the response would be information about availability of resource (YES/NO).

2. Second one is getting information of a resource. This does not mean that the resource ‘exists’ in the system, although first procedure may be used in advance to know it. If a resource exists its related information is returned accordingly. Same aforementioned paradigms can be followed, as shown in FIG. 3:

a) Providing semantic about resource (and condition) in the query itself (e.g. get‘Resource’Info/get‘Resource’InfoPerCondition are examples for primitives names replacing ‘Resource’ for the name of the resource). Furthermore, the procedure may be provided with some added flexibility to query ‘resource information’ under some criteria/conditions (e.g. get‘Resource’Info/get‘Resource’InfoPerCondition (criteria [ ]))

b) Identifying the resource (and conditions) explicitly in the query (e.g. getInfo/getInfoPerCondition (resource, criteria [ ]). In the same fashion as before, criteria may be used to establish some query conditions.

Regardless the paradigm to be followed, the response would contain valuable information about resource as per resource name, some descriptive information and some considerations about its use or purpose.
Discovery of resources under a criteria

Basically, this functionality consists of adding a criteria or a set of criteria (i.e. conditions) under the query in order to check the existence of a resource existence or to get resource information. Returned information may be more detailed or applicable depending on the criteria.

At least the following criteria are defined:
Checking availability/Getting Info per User. Based on resource owner: when Resource owner is known (by means of an identity, i.e. internal identifier, nickName, MSISDN, IP . . . )
Checking availability/Getting Info per Country/Organization. Based on resource belonging to a Country/Organization: when resource owner country or similar (Operator, company . . . ) is known
Checking availability/Getting Info per Location. Based on the resource owner location: when the resource owner location is known.
Checking availability/Getting per Resource Characteristics: (Here, it may be developed a wide set of scenarios as per following)
   Per security access considerations (e.g. resources available using certaing security access mechanism or authentication schema)
   Per policy criteria (e.g.: resources available at given time/date, for children, etc.)
   Per charging behavior (e.g.: resources which usage is for free, which usage implies charging the resource owner or a third party, etc.)

These criteria not only limit the discovery procedure but also enables for a customized response under the considerations formulated in the query.
Information returned in getting Resource Information Query

Not precluding other information main information returned per a resource would be:
Name
Description
EndPoint to give access to it

Furthermore, other information may be included in the response:
Security Access Conditions (e.g. security access mechanism)
Policy Information (access time conditions, bandwidth access policy limitations . . . )
Charging behavior (if its use is charged or not, charging conditions, . . . )

As it may be foreseen, the ‘criteria’ concept enables giving flexibility and scalability for both aforementioned points.

These procedures/operations are technology-independent. This means they define a mechanism to be followed for system databases resources information and different technologies may be used to implement them (HTTP REST, Web Services (SOAP), RPC-XML, Java, C++ . . . ).

Besides it, and based on former point, this procedure is extensible for a huge range of Applications.

The ‘discovery resource’ mechanism presents several advantages with respect to current status of the art.
Criteria based discovery: ‘criteria-based’ concept, as an addition to existing solutions, enables in a single request to be able to discover the resource as well as to obtain relevant and suitable information of it under certain conditions (e.g. accessible/available for a certain scenario), which also provides flexibility/customization in the response.
Simplicity of the solution: mechanism is very simple, only two procedures are defined.
Extensibility and scalability: mechanism is easily extensible by combining resource/criteria parameterization. Due to this is scalable as well for wider systems
Flexibility for applications: the aforementioned mechanism is fully compatible for both internet-based and non-internet based applications giving it a world-wide scope. Besides that, the ‘discovery resource’ mechanism does not preclude any type of application to be taken advantage of it.
Multipurpose-oriented: this mechanism of identifying resources/obtaining information about them is multipurpose-oriented enabling to be used as a medium to get other aims. It is not only a final procedure itself but also a way to get/enrich other procedures.

A person skilled in the art could introduce changes and modifications in the embodiments described without departing from the scope of the invention as it is defined in the attached claims.

### ACRONYMS

ANSI American National Standards Institute

API Application Program Interface

CQL Contextual Query Language

HTTP Hypertext Transfer Protocol

NISO National Information Standards Organization

REST Representational State Transfer

SOAP Simple Object Access Protocol

SRU Search-Retrieve via URL

SRW Search-Retrieve Web service

UI User Interface

URL Uniform Resource Locator

XML eXtensible Markup Language

XRDS eXtensible Resource Descriptor Sequence

XRI eXtensible Resource identifier

### REFERENCES

[1] Standard Information Retrieval (Z39.50): Application Service Definition and Protocol Specification. http://www.loc.gov/z3950/agency/
[2] SRU (Search/Retrieve Via URL). http://www.loc.gov/standards/sru/
[3]SRW (Search/Retrieve Web Service). http://www.loc.gov/standards/sru/specs/transport.html#soap
[4] CQL (Contextual Query Language). http://www.loc.gov/standards/sru/specs/cql.html
[5] XRI (Extensible Resource Identifier). http://docs.oasis-open.org/xri/2.0/specs/xri-resolution-V2.0.html

1-13. (canceled)

14. A method for querying a resource through Internet, wherein said resource is an item used within system databases to group or nest related information stored in said system databases, the method comprising checking the existence and availability of said unknown resource and of information associated/related thereto and, if confirmed, obtaining said resource and at least part of said information associated/related thereto, by performing a query to a target database, where said query is constructed with no information about the underlying database structure of said target database, said resource associated/related information including at least one of resource name, resource descriptive information and resource purpose considerations, the method further comprises limiting the scope of the query, both for the resource and for the information associated/related thereto, by performing said query under at least a specific criterion or set of specific criteria selected among the next criteria: the resource owner, country of the resource owner, service provider of the resource owner, location of the resource owner, characteristics of said resource and on other contextual information of the resource owner.

15. The method as per claim 14, wherein said querying is performed by an entity invoking primitives to perform said checking and obtaining of said resource.

16. The method as per claim 15, comprising performing said checking of the existence of said resource by providing an identifier of said resource to the primitive which invokes said checking of the existence of said resource.

17. The method as per claim 15, comprising performing said obtaining of at least part of said related information by providing said identifier about said resource to the primitive which invokes said obtaining.

18. The method as per claim 16, wherein said identifier includes the name of said resource in the name or in the argument of said primitive.

19. The method as per claim 16, comprising providing said specific criterion or said set of conditions to said primitive.

20. The method as per claim 14, wherein said specific criterion when relates to said resource owner comprises at least one of: internal identifier of said system databases, nickname, alias, Mobile Subscriber Integrated Services Digital Network Number or IP.

21. The method as per claim 14, wherein said service provider is a telecommunication services provider or an internet services provider.

22. The method as per claim 14, wherein said specific criterion when relates to said resource characteristics comprises at least one of: resources which usage is for free, resources which usage requires a charge, resources available at given time or date, resources available with given BW characteristics, resources available for children or resources available using a certain security access mechanism or authentication procedure.

23. The method as per claim 14, wherein said contextual information is the information related to said resource owner behaviour, location or profile according to said system databases stored data.

24. The method as per claim 14, wherein said related information comprises at least one of: name of said resource, description of said resource or end point that gives access to said resource.

25. The method as per claim 14, wherein said related information further comprises at least one of: security access conditions, policy information or charging behaviour.

26. The method as per claim 14, wherein said related information further includes other information related to said resource meta-information, being said resource meta-information any information useful for accessing the resource.
